(19) United States
(12) Patent Application Publication
(10) Pub. No.: US 2008/0151570 A1
(43) Pub. Date: Jun. 26, 2008

(54) ARTISTIC LAMP ORNAMENT

(76) Inventor: Yuehong Lin, Shanghai (CN)

Correspondence Address: Levenfeld Pearlstein, LLC;Intellectual Property Department, 2 North LaSalle, Suite 1300, Chicago, IL, 60602, US

(21) Appl. No.: 11/959,189

(22) Filed: Dec. 18, 2007

(30) Foreign Application Priority Data
Dec. 20, 2006 (CN) 200620049223.8

(51) Int. Cl. F21S 13/14; F21V 5/00

(52) U.S. Cl. 362/565; 362/252

(57) ABSTRACT

The object of the present utility model is to provide an artistic lamp ornament which includes a figure body, characterized in that outside the figure body, there is provided with a light irradiating layer and outside the light irradiating layer there is provided with a decorative layer. The present utility model changes the irradiance point into an irradiance surface, which can be distributed equally on either inner or outer surface of the solid figure, namely the figure body so as to enlarge the surface of heat dissipation and prolong the life span of the products. Meanwhile, the aesthetic effect can be greatly improved due to the equal brightness of the products. The figure body of the present utility model can be made of a fiberglass reinforced plastic (FRP), and can be made large so as to cause much attraction to public viewers. The present utility model has also a merit that heat dissipation is improved, viewable distance prolonged and much attraction to the public viewers bettered.

### BACKGROUND OF THE UTILITY MODEL

1. Field of the Utility Model

The present utility model relates generally to a lamp decoration, and more particularly, to an artistic lamp ornament for creating aesthetic festival atmosphere.

2. Description of the Prior Art

Available lamp decorations are to place one or more light bulbs into a hollow plastic part which may exhibit a style of model figure because of the light from the plastic part when powered.

However this kind of the lamp decorations may have following disadvantages:

A. The decorations can not be made large due to the limitation in the model's size as well the appearance in view of the current mould blowing technique;

B. The decorations are not ideal in heat dissipation due to the placement of one or more bulbs in the hollow plastic part. This further incurs light attenuation when light rays transmit the plastic part, and thus viewable distance is reduced;

C. The decorations can not be lighted thoroughly because light source is normally positioned at one point or one surface, and thus aesthetic effect is dissatisfactory.

### SUMMARY OF THE UTILITY MODEL

The object of the present utility model is to provide an artistic lamp ornament which exhibits a better appearance and has an improved heat dissipation effect. With the lamp ornament of the present utility model, the viewable distance is prolonged and the attraction to the viewers is enhanced.

This object is realized by providing an ornament which has a figure body provided therein with a layer of light irradiating substance.

The artistic lamp ornament of the present utility model is characterized in its figure body inside which a layer of light irradiating substance and outside which a layer of decorative material are respectively provided.

The artistic lamp ornament of the present utility model is characterized in its figure body outside which a layer of light irradiating substance is provided.

The artistic lamp ornament of the present utility model is characterized in its figure body outside which a layer of light irradiating substance and inside which a layer of decorative material are respectively provided.

The figure body can be of a fiberglass reinforced plastic (FRP) or a plastics; the layer of light irradiating substance can be a semiconductor LED, tungsten filament (bulbs) or optical fiber, which are connected in series or in parallel. Said layer of decorative material can be a layer of plastic of color transparency or complete transparency.

The present utility model adopts a layer of light irradiation instead of a point of light irradiation equally distributed on the inner or outer surface of the solid body, namely the figure body. Therefore, the heat dissipation area can be enlarged and the life span of the product can be prolonged. Moreover, the aesthetic effect is greatly strengthened due to the even brightness effect.

Because the present utility model is made from a fiberglass reinforced plastic (FRP), it can be made large and attraction to the viewers is thus strengthened.

The present utility model can improve heat dissipation, prolong viewable distance and improve aesthetic attraction to the viewers.

### BRIEF DESCRIPTION OF THE DRAWINGS

FIGS. 1 and 2 schematically show the structure of the artistic of lamp ornaments shaped in tiger figures;

FIGS. 3 and 4 schematically show the structure of the artistic of lamp ornaments shaped in snowman figures;

FIGS. 5 and 6 schematically show the structure of the artistic of lamp ornaments shaped in polar bear figures;

FIGS. 7 and 8 schematically show the structure of the artistic of lamp ornaments shaped in Santa Claus figures;

FIG. 9 schematically shows the structure of the artistic of lamp ornament shaped in lion figure;

FIG. 10 schematically shows the structure of the artistic of lamp ornament shaped in panther figure;

FIG. 11 schematically shows the structure of the artistic of lamp ornament shaped in elephant figure;

FIG. 12 schematically shows the structure of the artistic of lamp ornament shaped in camel figure;

FIG. 13 schematically shows the structure of the artistic of lamp ornament shaped in cattle figure;

FIG. 14 schematically shows the structure of the artistic of lamp ornament shaped in horse figure;

FIG. 15 schematically shows the structure of the artistic of lamp ornament shaped in sheep figure;

FIG. 16 schematically shows the structure of the artistic of lamp ornament shaped in deer figure;

FIG. 17 schematically shows the structure of the artistic of lamp ornament shaped in reindeer figure;

FIG. 18 schematically shows the structure of the artistic of lamp ornament shaped in giraffe figure;

FIG. 19 schematically shows the structure of the artistic of lamp ornament shaped in panda figure;

FIG. 20 schematically shows the structure of the artistic of lamp ornament shaped in crocodile figure;

FIG. 21 schematically shows the structure of the artistic of lamp ornament shaped in tortoise figure;

FIG. 22 schematically shows the structure of the artistic of lamp ornament shaped in flamingo figure;

FIG. 23 schematically shows the structure of the artistic of lamp ornament shaped in hawk figure;

FIG. 24 schematically shows the structure of the artistic of lamp ornament shaped in kangaroo figure;

FIG. 25 schematically shows the structure of the artistic of lamp ornament shaped in koala figure;

FIG. 26 schematically shows the structure of the artistic of lamp ornament shaped in penguin figure;

FIG. 27 schematically shows the structure of the artistic of lamp ornament shaped in swan figure;

FIG. 28 schematically shows the structure of the artistic of lamp ornament shaped in goose figure;

FIG. 29 schematically shows the structure of the artistic of lamp ornament shaped in duck figure;

FIG. 30 schematically shows the structure of the artistic of lamp ornament shaped in cat figure;

FIG. 31 schematically shows the structure of the artistic of lamp ornament shaped in dog figure;

FIG. 32 schematically shows the structure of the artistic of lamp ornament shaped in angel figure;

FIG. 33 schematically shows the structure of the artistic of lamp ornament shaped in pentagram figure;

FIG. 34 schematically shows the structure of the artistic of lamp ornament shaped in snowflake figure;

FIG. 35 schematically shows the structure of the artistic of lamp ornament shaped in pentagram figure;

FIG. 36 schematically shows the structure of the artistic of lamp ornament shaped in Christmas tree figure; and

FIG. 37 schematically shows the structure of the artistic of lamp ornament shaped in English character.

### DETAILED DESCRIPTION OF THE METHOD

Embodiments of the present utility model will be described in detail in reference to the accompanying figures.

### Embodiment 1

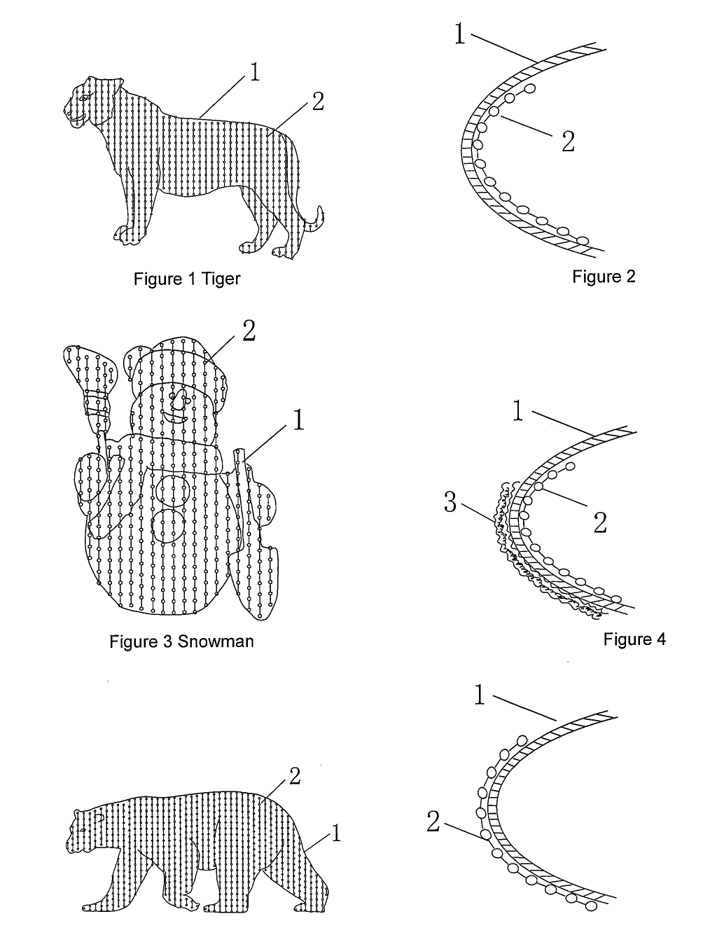

FIGS. 1 and 2 schematically show the structure of the artistic of lamp ornaments shaped in tiger figures which are composed of tiger figure body 1 and light irradiating layer 2. Figure body 1 is of a fiberglass reinforced plastic (FRP), and light irradiating layer 2 can be tungsten filament irradiating bulbs connected in series or in parallel.

Inside figure body 1 it is provided with light irradiating layer 2, and figure body 1 can be shaped in a human or an animal.

### Embodiment 2

FIGS. 3 and 4 schematically show the structure of the artistic of lamp ornaments shaped in snowman figures which are composed of snowman figure body 1, light irradiating layer 2 and decorative layer 3. Figure body 1 is of a fiberglass reinforced plastic. A light irradiating layer 2 is provided in snowman figure body 1 and can be a semiconductor LED connected in series or in parallel. Outside figure body 1, there is provided with a decorative layer 3 which is a plastic layer of color transparency or complete transparency.

Figure body 1 can be shaped in a human or an animal.

### Embodiment 3

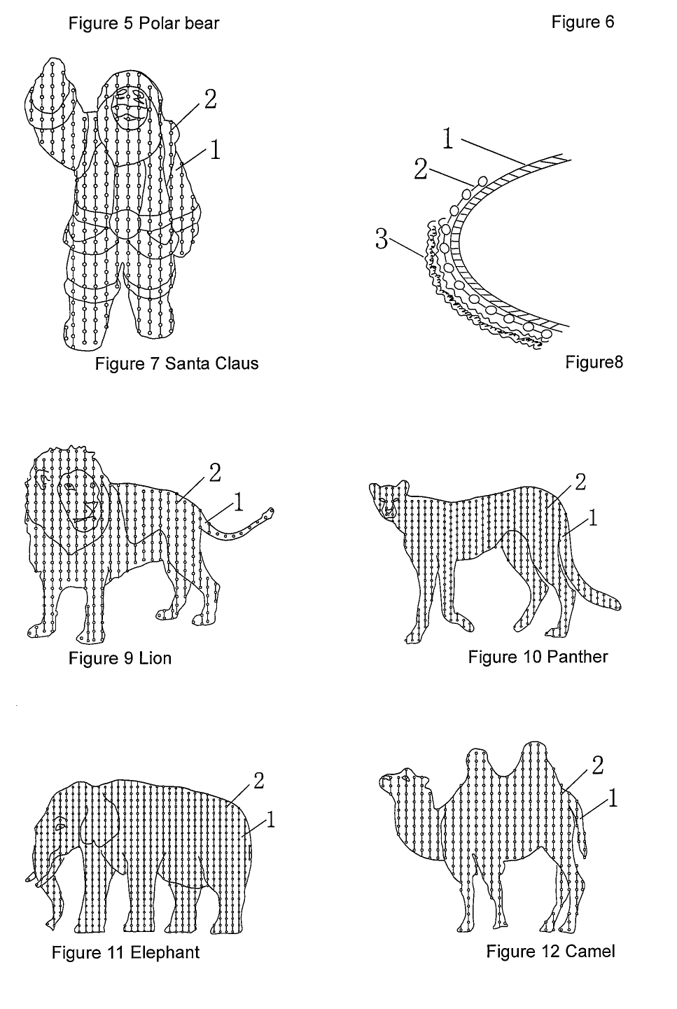

FIGS. 5 and 6 schematically show the structure of the artistic of lamp ornaments shaped in polar bear figures which are composed of polar bear figure body 1 and light irradiating layer 2. Figure body 1 is of a plastic. A light irradiating layer 2 is provided outside polar bear figure body 1 and can be an optic fiber connected in series or in parallel.

### Embodiment 4

FIGS. 7 and 8 schematically show the structure of the artistic of lamp ornaments shaped in Santa Claus figures which are composed of Santa Claus figure body 1, light irradiating layer 2 and decorative layer 3. Figure body 1 is of a fiberglass reinforced plastic. A light irradiating layer 2 is provided in Santa Claus figure body 1 and can be a semiconductor LED connected in series or in parallel. Outside light irradiating layer 2, there is further provided with a decorative layer 3 which is a plastic layer of color transparency or complete transparency.

### Embodiment 5

FIG. 9 schematically shows the structure of the artistic of lamp ornament shaped in lion figure which is composed of lion figure body 1, light irradiating layer 2 and decorative layer 3. Other part of the ornament is structured as those in embodiment 4.

### Embodiment 6

FIG. 10 schematically shows the structure of the artistic of lamp ornament shaped in panther figure which is composed of panther figure body 1, light irradiating layer 2 and decorative layer 3. Other part of the ornament is structured as those in embodiment 4.

### Embodiment 7

FIG. 11 schematically shows the structure of the artistic of lamp ornament shaped in elephant figure which is composed of elephant figure body 1, light irradiating layer 2 and decorative layer 3. Other part of the ornament is structured as those in embodiment 4.

### Embodiment 8

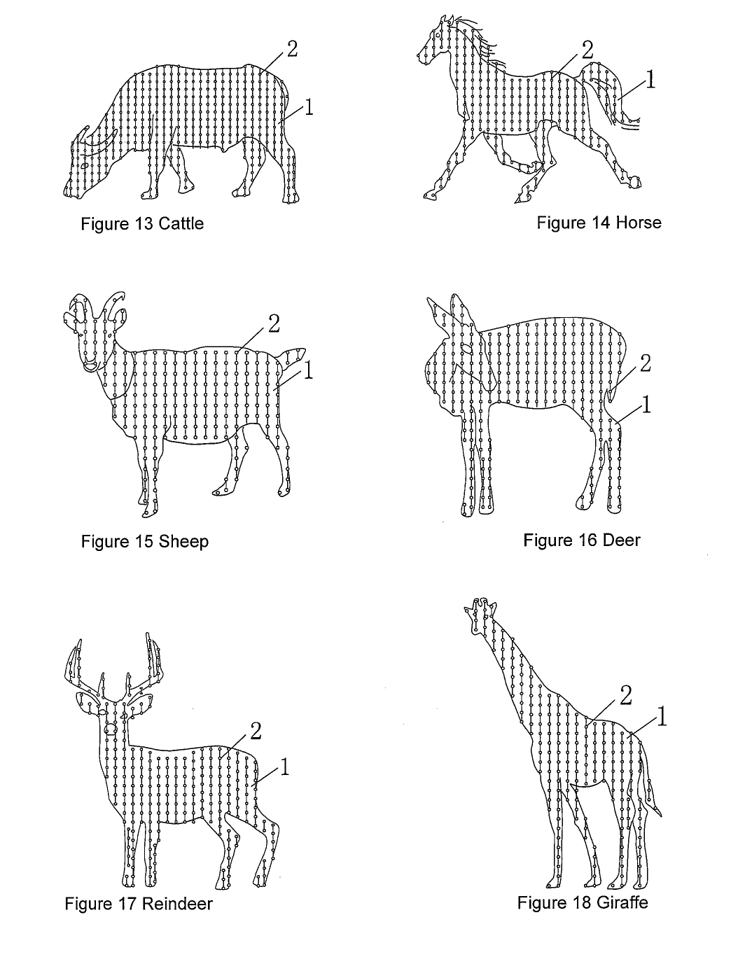

FIG. 12 schematically shows the structure of the artistic of lamp ornament shaped in camel figure which is composed of camel figure body 1, light irradiating layer 2 and decorative layer 3. Other part of the ornament is structured as those in embodiment 4.

### Embodiment 9

FIG. 13 schematically shows the structure of the artistic of lamp ornament shaped in cattle figure which is composed of cattle figure body 1, light irradiating layer 2 and decorative layer 3. Other part of the ornament is structured as those in embodiment 4.

### Embodiment 10

FIG. 14 schematically shows the structure of the artistic of lamp ornament shaped in horse figure which is composed of horse figure body 1, light irradiating layer 2 and decorative layer 3. Other part of the ornament is structured as those in embodiment 4.

### Embodiment 11

FIG. 15 schematically shows the structure of the artistic of lamp ornament shaped in sheep figure which is composed of sheep figure body 1, light irradiating layer 2 and decorative layer 3. Other part of the ornament is structured as those in embodiment 4.

### Embodiment 12

FIG. 16 schematically shows the structure of the artistic of lamp ornament shaped in deer figure which is composed of deer figure body 1, light irradiating layer 2 and decorative layer 3. Other part of the ornament is structured as those in embodiment 4.

### Embodiment 13

FIG. 17 schematically shows the structure of the artistic of lamp ornament shaped in reindeer figure which is composed of reindeer figure body 1, light irradiating layer 2 and decorative layer 3. Other part of the ornament is structured as those in embodiment 4.

### Embodiment 14

FIG. 18 schematically shows the structure of the artistic of lamp ornament shaped in giraffe figure which is composed of giraffe figure body 1, light irradiating layer 2 and decorative layer 3. Other part of the ornament is structured as those in embodiment 4.

### Embodiment 15

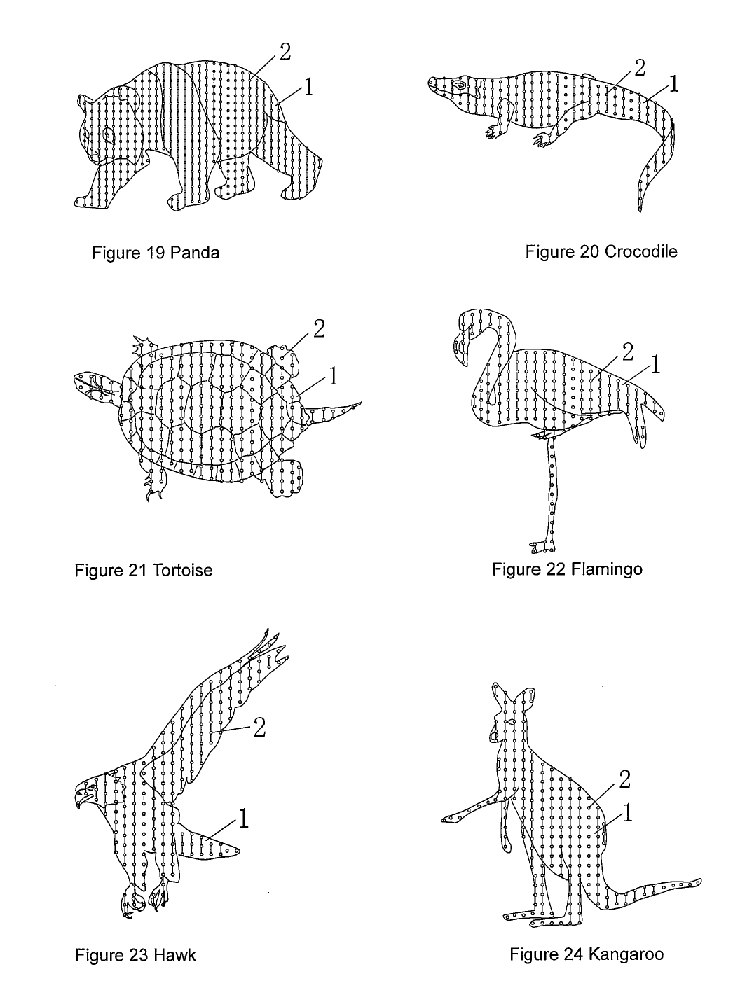

FIG. 19 schematically shows the structure of the artistic of lamp ornament shaped in panda figure which is composed of panda figure body 1, light irradiating layer 2 and decorative layer 3. Other part of the ornament is structured as those in embodiment 4.

### Embodiment 16

FIG. 20 schematically shows the structure of the artistic of lamp ornament shaped in crocodile figure which is composed of crocodile figure body 1, light irradiating layer 2 and decorative layer 3. Other part of the ornament is structured as those in embodiment 4.

### Embodiment 17

FIG. 21 schematically shows the structure of the artistic of lamp ornament shaped in tortoise figure which is composed of tortoise figure body 1, light irradiating layer 2 and decorative layer 3. Other part of the ornament is structured as those in embodiment 4.

### Embodiment 18

FIG. 22 schematically shows the structure of the artistic of lamp ornament shaped in flamingo figure which is composed of flamingo figure body 1, light irradiating layer 2 and decorative layer 3. Other part of the ornament is structured as those in embodiment 4.

### Embodiment 19

FIG. 23 schematically shows the structure of the artistic of lamp ornament shaped in hawk figure which is composed of hawk figure body 1, light irradiating layer 2 and decorative layer 3. Other part of the ornament is structured as those in embodiment 4.

### Embodiment 20

FIG. 24 schematically shows the structure of the artistic of lamp ornament shaped in kangaroo figure which is composed of kangaroo figure body 1, light irradiating layer 2 and decorative layer 3. Other part of the ornament is structured as those in embodiment 4.

### Embodiment 21

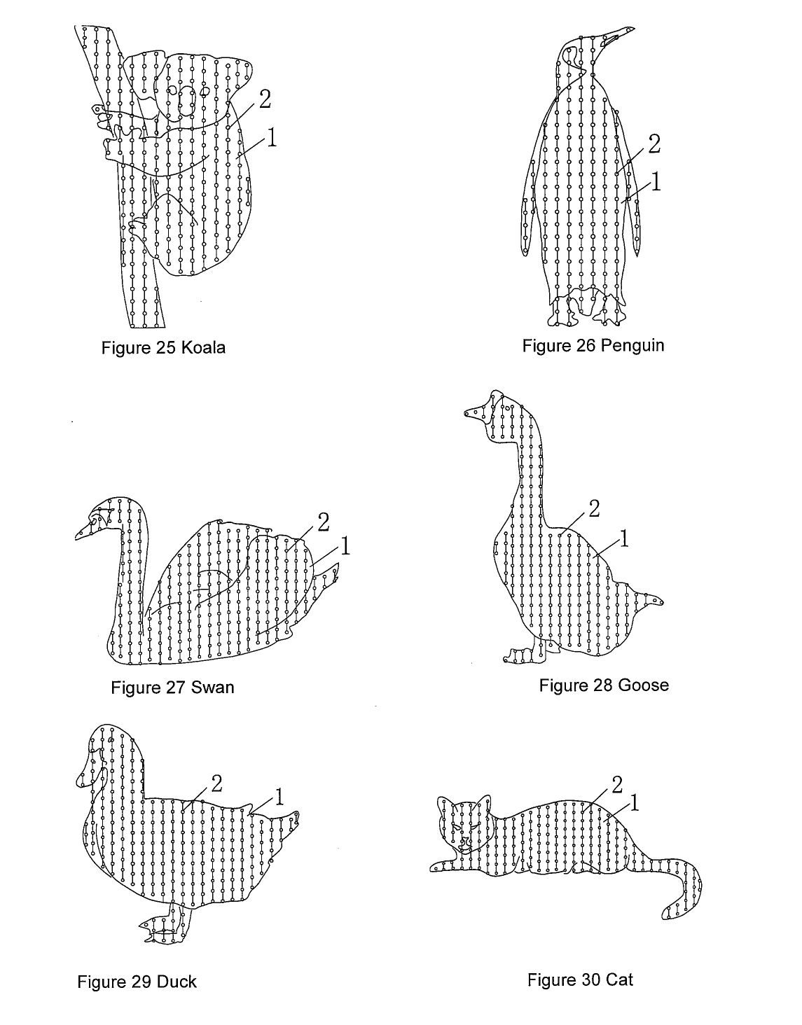

FIG. 25 schematically shows the structure of the artistic of lamp ornament shaped in koala figure which is composed of koala figure body 1, light irradiating layer 2 and decorative layer 3. Other part of the ornament is structured as those in embodiment 4.

### Embodiment 22

FIG. 26 schematically shows the structure of the artistic of lamp ornament shaped in penguin figure which is composed of penguin figure body 1, light irradiating layer 2 and decorative layer 3. Other part of the ornament is structured as those in embodiment 4.

### Embodiment 23

FIG. 27 schematically shows the structure of the artistic of lamp ornament shaped in swan figure which is composed of swan figure body 1, light irradiating layer 2 and decorative layer 3. Other part of the ornament is structured as those in embodiment 4.

### Embodiment 24

FIG. 28 schematically shows the structure of the artistic of lamp ornament shaped in goose figure which is composed of goose figure body 1, light irradiating layer 2 and decorative layer 3. Other part of the ornament is structured as those in embodiment 4.

### Embodiment 25

FIG. 29 schematically shows the structure of the artistic of lamp ornament shaped in duck figure which is composed of duck figure body 1, light irradiating layer 2 and decorative layer 3. Other part of the ornament is structured as those in embodiment 4.

### Embodiment 26

FIG. 30 schematically shows the structure of the artistic of lamp ornament shaped in cat figure which is composed of cat figure body 1, light irradiating layer 2 and decorative layer 3. Other part of the ornament is structured as those in embodiment 4.

### Embodiment 27

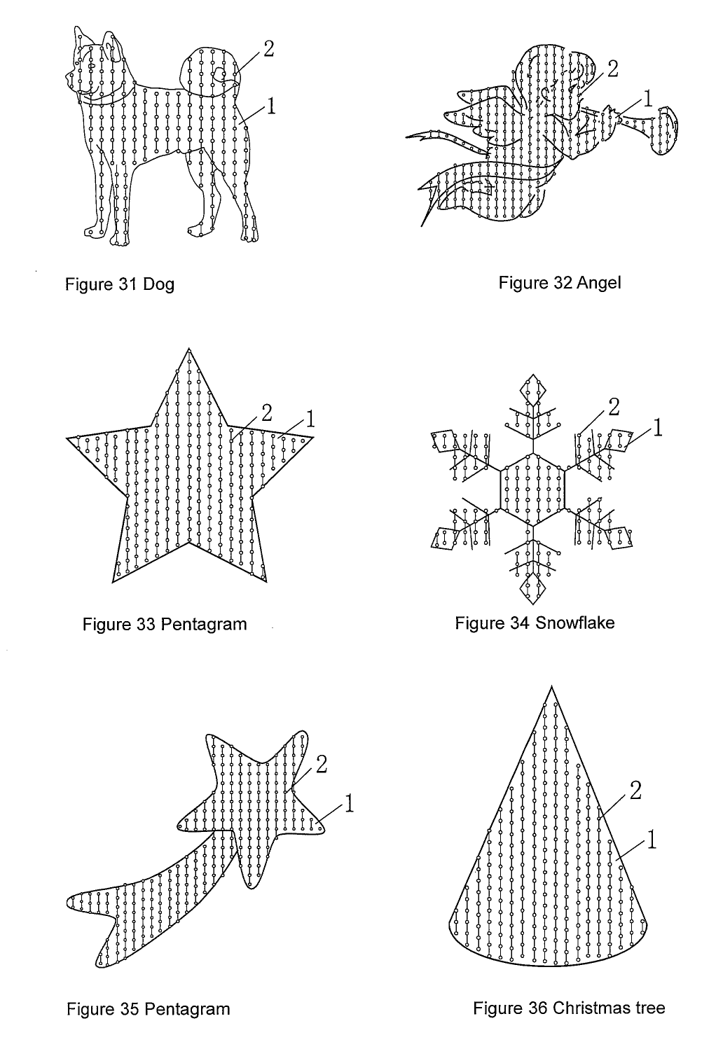

FIG. 31 schematically shows the structure of the artistic of lamp ornament shaped in dog figure which is composed of dog figure body 1, light irradiating layer 2 and decorative layer 3. Other part of the ornament is structured as those in embodiment 4.

### Embodiment 28

FIG. 32 schematically shows the structure of the artistic of lamp ornament shaped in angel figure which is composed of angel figure body 1, light irradiating layer 2 and decorative layer 3. Other part of the ornament is structured as those in embodiment 4.

FIG. 33 schematically shows the structure of the artistic of lamp ornament shaped in pentagram figure which is composed of pentagram figure body 1, light irradiating layer 2 and decorative layer 3. Other part of the ornament is structured as those in embodiment 4.

FIG. 34 schematically shows the structure of the artistic of lamp ornament shaped in snowflake figure which is composed of snowflake figure body 1, light irradiating layer 2 and decorative layer 3. Other part of the ornament is structured as those in embodiment 4.

FIG. 35 schematically shows the structure of the artistic of lamp ornament shaped in small pentagram figure which is composed of pentagram figure body 1, light irradiating layer 2 and decorative layer 3. Other part of the ornament is structured as those in embodiment 4.

FIG. 36 schematically shows the structure of the artistic of lamp ornament shaped in a Christmas tree figure which is composed of Christmas tree figure body 1, light irradiating layer 2 and decorative layer 3. Other part of the ornament is structured as those in embodiment 4.

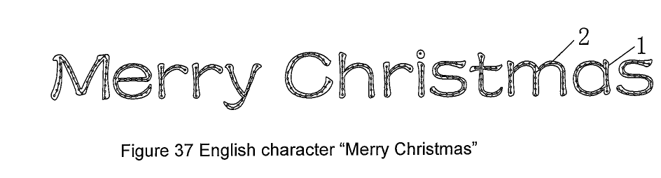

FIG. 37 schematically shows the structure of the artistic of lamp ornament shaped in an English character figure which is composed of English character figure body 1, light irradiating layer 2 and decorative layer 3. Other part of the ornament is structured as those in embodiment 4.

1. An artistic lamp ornament, comprising a figure body (1) provided with a light irradiating layer (2) therein.

2. An artistic lamp ornament, comprising a figure body (1) provided with a light irradiating layer (2) therein and an ornamental layer (3) there-out.

3. An artistic lamp ornament, comprising a figure body (1) provided with a light irradiating layer (2) there-out.

4. An artistic lamp ornament, comprising a figure body (1) provided with a light irradiating layer (2) there-out and outside said light irradiating layer (2) there is provided with an ornamental layer (3).

5. The artistic lamp ornament according to claim 1, wherein said figure body (1) can be of the material of fiberglass reinforced plastic (FRP) or plastics.

6. The artistic lamp ornament according to claim 1, wherein said light irradiating layer (2) can be a semiconductor LED, tungsten filament (bulbs) or optical fiber connected in series or in parallel.

7. The artistic lamp ornament according to claim 1, wherein said ornamental layer (3) can be a plastic layer of color transparency or complete transparency.

8. The artistic lamp ornament according to claim 2, wherein said figure body (1) can be of the material of fiberglass reinforced plastic (FRP) or plastics.

9. The artistic lamp ornament according to claim 2, wherein said light irradiating layer (2) can be a semiconductor LED, tungsten filament (bulbs) or optical fiber connected in series or in parallel.

10. The artistic lamp ornament according to claim 2, wherein said ornamental layer (3) can be a plastic layer of color transparency or complete transparency.

11. The artistic lamp ornament according to claim 3, wherein said figure body (1) can be of the material of fiberglass reinforced plastic (FRP) or plastics.

12. The artistic lamp ornament according to claim 3, wherein said light irradiating layer (2) can be a semiconductor LED, tungsten filament (bulbs) or optical fiber connected in series or in parallel.

13. The artistic lamp ornament according to claim 3, wherein said ornamental layer (3) can be a plastic layer of color transparency or complete transparency.

14. The artistic lamp ornament according to claim 4, wherein said figure body (1) can be of the material of fiberglass reinforced plastic (FRP) or plastics.

15. The artistic lamp ornament according to claim 4, wherein said light irradiating layer (2) can be a semiconductor LED, tungsten filament (bulbs) or optical fiber connected in series or in parallel.

16. The artistic lamp ornament according to claim 4, wherein said ornamental layer (3) can be a plastic layer of color transparency or complete transparency.
